(19) United States
(12) Patent Application Publication
(10) Pub. No.: US 2015/0291176 A1
(43) Pub. Date: Oct. 15, 2015

(54) APPARATUS AND METHOD OF ESTIMATING ROAD SLOPE BY USING GRAVITATIONAL ACCELERATION SENSOR

(71) Applicants: Hyundai Motor Company, Seoul (KR); Kia Motors Corporation, Seoul (KR)

(72) Inventors: Donghoon JEONG, Osan-si (KR); Byeongwook JEON, Seoul (KR)

(73) Assignees: Hyundai Motor Company, Seoul (KR); Kia Motors Corporation, Seoul (KR)

(21) Appl. No.: 14/542,199

(22) Filed: Nov. 14, 2014

(30) Foreign Application Priority Data
Apr. 14, 2014 (KR) 10-2014-0044240

(51) Int. Cl. B60W 40/076; G01C 21/26

(52) U.S. Cl. CPC B60W 40/076; G01C 21/26

(57) ABSTRACT

An apparatus for estimating road slope by using a gravitational acceleration sensor may include a data detector configured to detect data for estimating road slope, a navigation device configured to output road information according to a location of a vehicle, and a controller configured to correct an error of the gravitational acceleration sensor by using an altitude value detected by the data detector and a current altitude of the vehicle according to the road information received from the navigation device.

### CROSS-REFERENCE TO RELATED APPLICATION

This application claims priority to Korean Patent Application No. 10-2014-0044240 filed Apr. 14, 2014, the entire contents of which is incorporated herein for all purposes by this reference.

### BACKGROUND OF THE INVENTION

1. Field of the Invention

The present invention relates to an apparatus and method of estimating road slope by using a gravitational acceleration sensor. More particularly, the present invention relates to an apparatus and method of estimating road slope by using a gravitational acceleration sensor that corrects an error in accordance with an installation angle of the gravitational acceleration sensor by using a global positioning system (GPS) sensor and road information.

2. Description of Related Art

Generally, methods of estimating road slope are classified into a method using a driving torque and a method using a gravitational acceleration sensor.

A load of the vehicle changes depending on road slope, so an increase rate of a vehicle speed regarding the driving torque is changed according to road slope. Thus, the method of estimating road slope by using the driving torque estimates road slope by using a difference of the increase rate of the vehicle speed. The method of estimating road slope by using the driving torque can estimate road slope without an additional sensor. However, the method of estimating road slope by using the driving torque cannot correctly estimate road slope due to change of the driving torque. Thus, an excessive error of road slope occurs due to change of the driving torque. Moreover, the method of estimating road slope by using the driving torque cannot distinguish a load of road slope from a load of carrying freight or towing.

On the other hand, the method of estimating road slope by using the gravitational acceleration sensor detects a longitudinal acceleration when the vehicle is located on a slope. Thus, the method of estimating road slope by using the gravitational acceleration sensor calculates a pitching slope of the vehicle by comparing the longitudinal acceleration with the increase rate of the vehicle speed. Since the pitching slope is road slope if wheels of the vehicle have a fixed height, the method of estimating road slope by using the gravitational acceleration sensor can estimate road slope regardless of the driving torque. Also, the method of estimating road slope by using the gravitational acceleration sensor can estimate road slope even though the vehicle carries freight or is towed.

The method of estimating road slope by using the gravitational acceleration sensor has high accuracy and fast responsiveness compared to the method of estimating road slope by using the driving torque. However, an error occurs in accordance with an installation angle of the gravitational acceleration sensor.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus for and a method of estimating road slope by using a gravitational acceleration sensor having advantages of correcting an error in accordance with an installation angle of the gravitational acceleration sensor by using a global positioning system (GPS) sensor and road information.

According to various aspects of the present invention, an apparatus for estimating road slope by using a gravitational acceleration sensor may include a data detector configured to detect data for estimating road slope, a navigation device configured to output road information according to a location of a vehicle, and a controller configured to correct an error of the gravitational acceleration sensor by using an altitude value detected by the data detector and a current altitude of the vehicle according to the road information received from the navigation device.

The data detector may include a gravitational acceleration sensor configured to detect a horizontal acceleration and a longitudinal acceleration of the vehicle, and a global positioning system (GPS) sensor configured to detect the current altitude value of the vehicle.

The data may include information on at least one of a speed of the vehicle, a shift-speed of the vehicle, and a steering angle of the vehicle.

The navigation device may output the road information according to the location of the vehicle at predetermined time intervals.

The controller may calculate an offset value by using a difference between the altitude detected by the data detector and the current altitude of the vehicle according to the road information received from the navigation device.

The controller may correct the error of the gravitational acceleration sensor by updating the offset value when the vehicle runs more than a predetermined distance.

According to various aspects of the present invention, a method of estimating road slope by using a gravitational acceleration sensor that may include receiving altitude information from a navigation device, calculating a current altitude of the vehicle based on the received altitude information, calculating an offset value based on a difference between an altitude value detected by a global positioning system (GPS) sensor and the current altitude of the vehicle, and correcting an error of the gravitational acceleration sensor by using the offset value.

The method of estimating road slope by using a gravitational acceleration sensor may further include updating the offset value when the vehicle runs more than a predetermined distance.

According to various embodiments of the present invention as described above, the error in accordance with an installation angle of the gravitational acceleration sensor can be corrected by using a global positioning system (GPS) sensor and road information. Therefore, road slope can be estimated correctly by using the gravitational acceleration sensor.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary apparatus for estimating road slope by using a gravitational acceleration sensor according to the present invention.

FIG. 2 is a flowchart of an exemplary method of estimating road slope by using a gravitational acceleration sensor according to the present invention.

FIG. 3 is a drawing describing an estimating principle of road slope by using a gravitational acceleration sensor according to the present invention.

FIG. 4 is a drawing describing a principle for correcting an error of the gravitational acceleration sensor according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout this specification and the claims which follow, unless explicitly described to the contrary, the word “comprise” and variations such as “comprises” or “comprising” will be understood to imply the inclusion of stated elements but not the exclusion of any other elements.

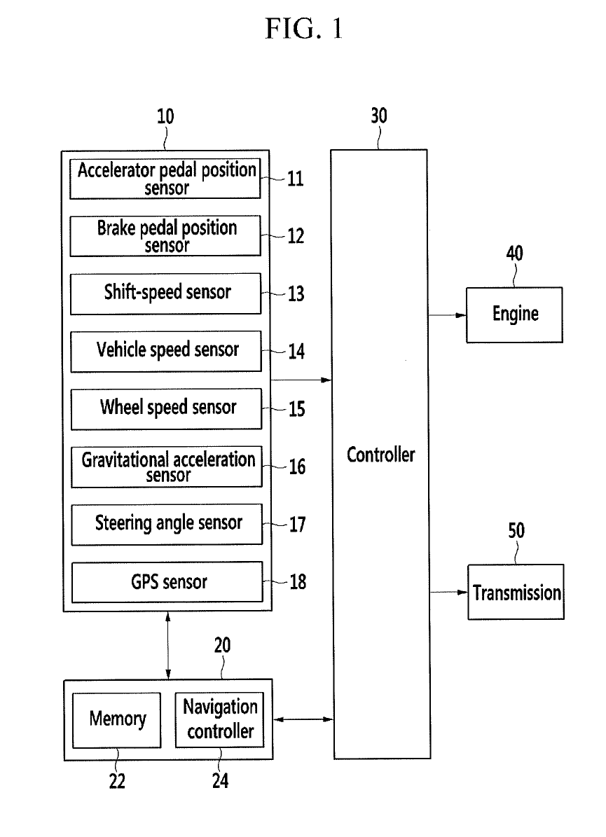

FIG. 1 is a block diagram of an apparatus for estimating road slope by using a gravitational acceleration sensor according to various embodiments of the present invention.

As shown in FIG. 1, an apparatus for estimating road slope by using a gravitational acceleration sensor according to the present invention includes a data detector 10, a navigation device 20, a controller 30, an engine 40, and a transmission 50.

The data detector 10 detects data related to road slope estimation for determining a running state of the vehicle and controlling a shift of the vehicle, and the data detected by the data detector 10 is transmitted to the controller 30. The data detector 10 includes an accelerator pedal position sensor 11, a brake pedal position sensor 12, a shift-speed sensor 13, a vehicle speed sensor 14, a wheel speed sensor 15, a gravitational acceleration sensor 16, a steering angle sensor 17, and a global positioning system (GPS) sensor 18.

The accelerator pedal position sensor 11 detects a degree at which a driver pushes an accelerator pedal. That is, the accelerator pedal position sensor 11 detects data related to a driver's acceleration will.

The brake pedal position sensor 12 detects whether a brake pedal is pushed or not. That is, the brake pedal position sensor 12 as well as the accelerator pedal position sensor 11 detect the driver's acceleration will.

The shift-speed sensor 13 detects a shift-speed that is currently engaged.

The vehicle speed sensor 14 detects a vehicle speed, and is mounted at a wheel of the vehicle. On the contrary, the vehicle speed may be calculated based on a signal received by the wheel speed sensor 15.

Meanwhile, a target shift-speed may be calculated by using a shift pattern based on the signal of the accelerator pedal position sensor 11 and the signal of the vehicle speed sensor 14, and the shift to the target shift-speed is thereby controlled. That is, hydraulic pressure supplied to a plurality of friction elements or released from a plurality of friction elements is controlled in an automatic transmission provided with a plurality of planetary gear sets and the plurality of friction elements. In addition, currents applied to a plurality of synchronizer devices and actuators are controlled in a double clutch transmission.

The wheel speed sensor 15 detects a wheel rotation speed of the vehicle, and is mounted at a wheel of the vehicle. The wheel speed sensor 15 controls a brake hydraulic pressure when the wheel of the vehicle slips according to quick braking.

The gravitational acceleration sensor 16 detects an acceleration of the vehicle. The gravitational acceleration sensor 16 may be mounted in addition to the vehicle speed sensor 14 and may directly detect the acceleration of the vehicle, or the gravitational acceleration sensor 16 may calculate the acceleration of the vehicle by differentiating the vehicle speed detected by the vehicle speed sensor 14.

Moreover, the gravitational acceleration sensor 16 may detect a longitudinal acceleration when the vehicle is located on a slope.

The steering angle sensor 17 detects a steering angle of the vehicle. That is, the steering angle sensor 17 detects a direction in which the vehicle runs.

The global position system (GPS) sensor 18 is a sensor for acquiring a location of the vehicle. According to current technologies, the GPS sensor 18 may calculate information regarding distances from three or more satellites and time information, and apply trigonometry to the calculated information to accurately calculate 3D current location information based on the latitude, the longitude, and the altitude. A method of calculating location and time information by using three satellites and correcting an error of the calculated location and time information by using a single satellite is commonly used. Also, the GPS sensor 18 may calculate information regarding a speed of a vehicle by continuously calculating a current location of the vehicle in real time.

The navigation device 20 is a device providing information regarding a route to a destination to the driver. The navigation device 20 may include a memory 22 storing compressed information regarding forward roads and a navigation controller 24 performing general control of the navigation device 20.

In addition, the navigation device 20 includes a wireless communication unit (not shown). The wireless communication unit may include one or more modules allowing for wireless communication between the navigation device 20 and a wireless communication system or between the navigation device 20 and a network in which the navigation device 20 is located.

The navigation device 20 may receive information regarding the vehicle from the data detector 10. The navigation device 20 may output road information according to a location of the vehicle by using the information received from the data detector 10 at predetermined time intervals.

The navigation device 20 described in the present invention may include a cellular phone, a smartphone, a laptop computer, a digital broadcast terminal, a personal digital assistant (PDA), a portable multimedia player (PMP), and the like.

The memory 22 may store a program for processing and controlling the navigation controller 24, or may serve to temporarily store input/output data (e.g., data detected by the data detector 10, map data of the navigation device 20, or the like). The memory 22 may store use frequency of each data.

The memory 22 may include at least one type of storage medium among a flash memory type, a hard disk type, a multimedia card micro type, a card type memory (e.g., SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The apparatus for processing road information may operate in relation to Web storage performing a storage function of the memory 22 on the Internet.

The controller 30 may control the engine 40 or the transmission 50 based on information output from the data detector 10 or the navigation device 20.

The controller 30 may calculate an offset value by using a difference between the altitude detected by the data detector 10 and the current altitude of the vehicle according to the road information received from the navigation device 20. The controller 30 may correct an error of the gravitational acceleration sensor by using the offset value and estimate road slope.

In addition, the controller 30 may update the offset value when the vehicle runs more than a predetermined distance. The controller 30 may estimate road slope after applying the updated offset value and correcting an error of the gravitational acceleration sensor.

The controller 30 may change a shift pattern, engaging feeling to the target shift-speed, an engine torque map, and/or an engine torque filter according to road slope calculated by correcting an error of the gravitational acceleration sensor.

For these purposes, the controller 30 may be implemented as at least one processor that is operated by a predetermined program, and the predetermined program may be programmed in order to perform each step of a method of estimating road slope by using the gravitational acceleration sensor according to an exemplary of the present invention.

Various embodiments described herein may be implemented within a recording medium that may be read by a computer or a similar device by using software, hardware, or a combination thereof, for example.

According to hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units designed to perform any other functions. In some cases, the embodiments described in the present invention may be implemented by the navigation controller 24 or the controller 30 itself.

According to software implementation, embodiments such as procedures and functions described in the various embodiments may be implemented by separate software modules. Each of the software modules may perform one or more functions and operations described in the present invention. A software code may be implemented by a software application written in an appropriate program language.

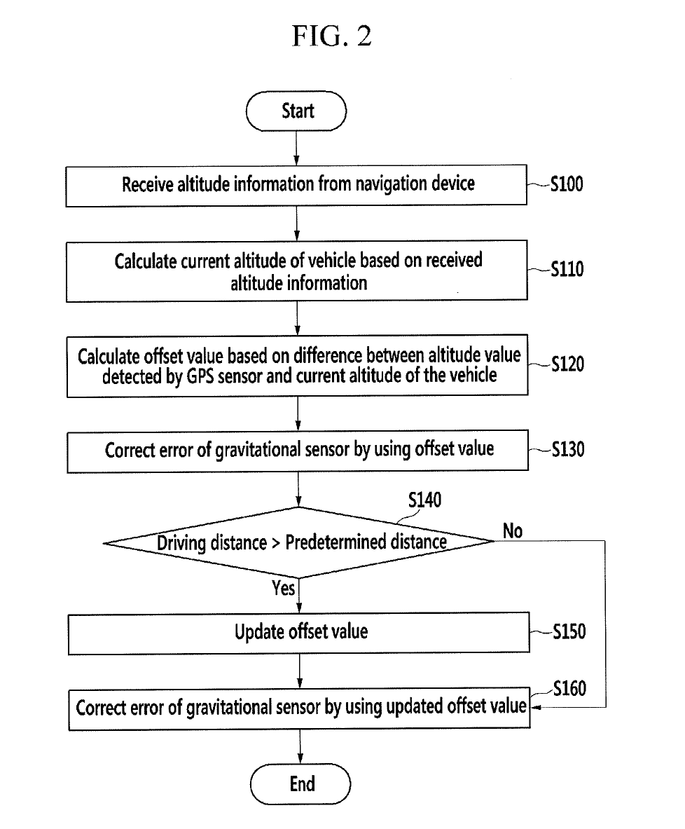

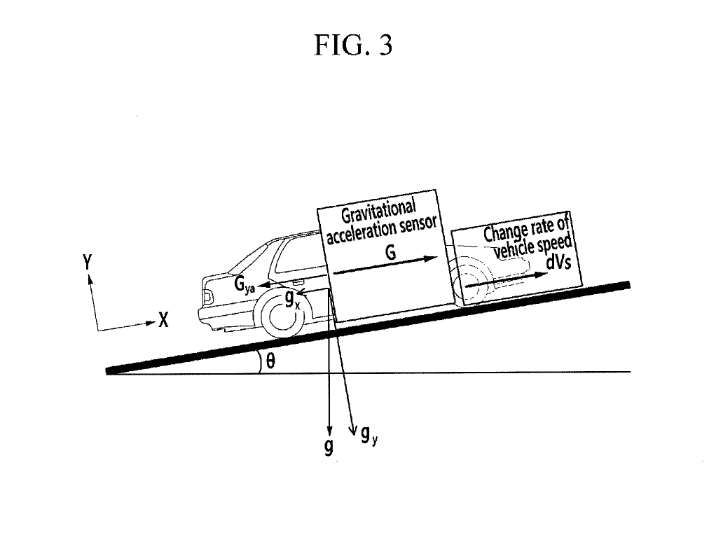

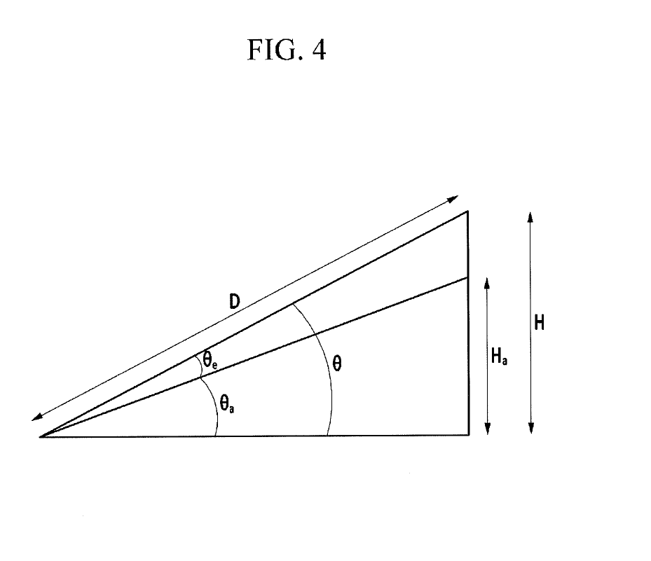

Hereinafter, a method of estimating road slope by using a gravitational acceleration sensor according to various embodiments of the present invention will be described in detail with reference to FIG. 2, FIG. 3, and FIG. 4.

FIG. 2 is a flowchart of a method of estimating road slope by using a gravitational acceleration sensor according to various embodiments of the present invention.

As shown in FIG. 2, a method of estimating road slope by using a gravitational acceleration sensor according to various embodiments of the present invention starts with receiving altitude information from the navigation device 20 at step S100.

The controller 30 calculates a current altitude of the vehicle based on the received altitude information at step S110.

After the current altitude of the vehicle is calculated at the step S110, the controller 30 calculates an offset value based on a difference between an altitude value detected by the GPS sensor 18 and the current altitude of the vehicle at step S120.

After that, the controller 30 corrects an error of the gravitational acceleration sensor by using the offset value at step S130.

A principle of correcting the error of the gravitational acceleration sensor by using the offset value will be described in detail with reference to FIG. 3 and FIG. 4.

FIG. 3 is a drawing describing an estimating principle of road slope by using a gravitational acceleration sensor according to various embodiments of the present invention, and FIG. 4 is a drawing describing a principle of correcting an error of the gravitational acceleration sensor according to various embodiments of the present invention.

Referring to FIG. 3, road slope may be calculated from the following equation.

Road slope(%)=tan θ*100=k*(G−dVs)

Here, an angle θ indicates a slope of the vehicle on a road, and it includes an installation angle of the gravitational acceleration sensor. G indicates progress direction (horizontal) acceleration of the vehicle, and dVs indicates a change rate of the vehicle speed.

Here, k may be calculated from the equation below.

$$k = \frac{1}{g \sqrt{1 - {sin}^{2} θ}}$$

In the above equation, g indicates gravity acceleration of the vehicle.

Since the θ includes the installation angle of the gravitational acceleration sensor as describes above, the error of the gravitational acceleration sensor occurs in accordance with the installation angle of the gravitational acceleration sensor while estimating road slope.

Therefore, the following equation is used in order to correct the error.

$$\begin{matrix}tan θ = tan ( {θ}_{a} + {θ}_{e} ) \\ = \frac{tan {θ}_{a} + tan {θ}_{e}}{1 + tan {θ}_{a} \cdot tan {θ}_{e}} \\ \approx tan {θ}_{a} + tan {θ}_{e} ∵ tan {θ}_{a} \cdot tan {θ}_{e} \\ \approx 0\end{matrix}$$

Here, tan θ indicates a whole road slope including the error due to installation angle of the gravitational acceleration sensor, tan θₐ indicates a real road slope, and tan θₑ indicates a road slope of as much as the error angle.

The real road slope may be calculated from the equation below.

$$\begin{matrix}tan {θ}_{a} \approx tan θ - tan {θ}_{e} \\ \approx tan θ - \frac{H - {H}_{a}}{D}\end{matrix}$$

Here, H indicates a current altitude of the vehicle according to the road information received from the navigation device 20, Ha indicates an altitude value detected by the GPS sensor 18, and D indicates a driving distance.

After correcting the error of the gravitational acceleration sensor by using the offset value, the controller 30 determines whether the vehicle runs more than a predetermined distance at step S140.

When the vehicle runs more than a predetermined distance (for example, more than 10 km) at the step S140, the controller 30 updates the offset value at step S150.

To this end, the controller 30 may store a previous offset value, and may set an altitude of the vehicle at an updating time as a current altitude of the vehicle.

After that, the controller 30 corrects the error of the gravitational acceleration sensor by applying the updated offset value at step S160.

According to various embodiments of the present invention as described above, the error in accordance with an installation angle of the gravitational acceleration sensor can be corrected by using the GPS sensor and road information, and the road slope can be estimated correctly.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for estimating road slope by using a gravitational acceleration sensor comprising:
a data detector configured to detect data for estimating road slope;
a navigation device configured to output road information according to a location of a vehicle; and
a controller configured to correct an error of the gravitational acceleration sensor by using an altitude value detected by the data detector and a current altitude of the vehicle according to the road information received from the navigation device.

2. The apparatus of claim 1, wherein the data detector comprises:
a gravitational acceleration sensor configured to detect a horizontal acceleration and a longitudinal acceleration of the vehicle; and
a global positioning system (GPS) sensor configured to detect the current altitude value of the vehicle.

3. The apparatus of claim 2, wherein the data includes information on at least one of a speed of the vehicle, a shift-speed of the vehicle, and a steering angle of the vehicle.

4. The apparatus of claim 1, wherein the navigation device outputs the road information according to the location of the vehicle at predetermined time intervals.

5. The apparatus of claim 1, wherein the controller calculates an offset value by using a difference between the altitude value detected by the data detector and the current altitude of the vehicle according to the road information received from the navigation device.

6. The apparatus of claim 5, wherein the controller corrects the error of the gravitational acceleration sensor by updating the offset value when the vehicle runs more than a predetermined distance.

7. A method of estimating road slope by using a gravitational acceleration sensor, comprising:
receiving altitude information from a navigation device;
calculating a current altitude of the vehicle based on the received altitude information;
calculating an offset value based on a difference between an altitude value detected by a global positioning system (GPS) sensor and the current altitude of the vehicle; and
correcting an error of the gravitational acceleration sensor by using the offset value.

8. The method of claim 7, further comprising updating the offset value when the vehicle runs more than a predetermined distance.
